(19) United States
(12) Patent Application Publication
(10) Pub. No.: US 2004/0135378 A1
(43) Pub. Date: Jul. 15, 2004

(54) Motor vehicle lock

(75) Inventors: Gregor Buedding, Duisburg (DE); Matthias Koerwer, Kreuznacn (DE); Siegfried Karge, Wuppertal (DE); Uwe Haarmann, Remscherd (DE)

Correspondence Address: NIXON PEABODY, LLP, 401 9TH STREET, NW, SUITE 900, WASINGTON, DC, 20004-2128, US

(73) Assignee: Brose Schliesssysteme GmbH & Co. KG, Wuppertal (DE)

(21) Appl. No.: 10/644,968

(22) Filed: Aug. 21, 2003

(30) Foreign Application Priority Data
Aug. 26, 2002 (DE) 102 39 734.1

(51) Int. Cl. E05C 3/06

(52) U.S. Cl. 292/216

(57) ABSTRACT

A motor vehicle hatch lock or the like, with a latch which is pivotable around an axis, with a ratchet which is pivotable around another axis, and with an actuator, the actuator having an actuating element with the engagement element located thereon. By actuating the actuator out of the initial position in a first direction the ratchet is raised by the actuating element for an opening assistance function, and by actuating the actuator out of the initial position in a second direction opposite the first direction, the actuating element is coupled to the latch and the latch is moved from the pre-catch position into the main catch position for a closing assistance function with the actuating element being coupled to the latch by a step-down gear.

### BACKGROUND OF THE INVENTION

1. Field of the Invention

This invention relates to a motor vehicle lock. The motor vehicle lock of the exemplary embodiments can include all suitable types of hood, hatch or door locks, with hood and hatch locks being of particular interest. The motor vehicle locks of the exemplary embodiments can be equipped with an opening assistance function, including motorized lifting of a ratchet, and with a closing assistance function, including motorized movement of a latch from a pre-catch into a main catch position.

2. Description of Related Art

A motor vehicle lock is shown in published German Patent Application DE 197 14 922 A1. This lock has two separate actuators, specifically an opening assistance actuator and a closing assistance actuator. Thus, the two actuators can each be designed specially for one of the two functions described above. This structure is advantageous the opening assistance function requires a much smaller forces or torque than required for the closing assistance function.

Furthermore, a motor vehicle lock of published German Patent Application DE 199 19 765 A1 ensures the two functions described above using a single actuator. In this lock, the actuator has a crank drive which can be coupled to both the lock latch and to the ratchet. When the crank drive is actuated in one direction first the latch can be moved from the pre-catch into the main catch position. As the crank drive continues to be actuated in the same direction then the ratchet can be raised.

Another, motor vehicle lock described in published German Patent Application DE 198 04 516 A1 illustrate the implementation of the two functions described above with only a single actuator for a rear hatch lock. The actuator has a drive motor which is connected via a floating clutch and a drive shaft to a cam, hereinafter called the actuating element. The actuating element can be moved by a drive motor so that the stop shoulders located on the actuating element can be caused to engage a driving projection which is located on the latch and to engage the ratchet.

When the actuating element is moved in the first direction, the actuating element engages the ratchet and lifts it—the opening assistance function. By moving the actuating element in the second opposite direction, the actuating element engages the driving projection on the latch and moves the latch from the pre-catch into the main catch position—closing assistance function. The closing assistance function is then triggered when the ratchet and latch have been moved into the pre-catch position by pressing on the rear hatch which was opened first. The corresponding evaluation of the component is undertaken in order to trigger the closing assistance function, i.e., when both the latch and also the ratchet have assumed the pre-catch position. In this lock there is also a single actuator for the two different functions which load the actuator differently.

One problem in the motor vehicle locks described is in the triggering. In order to avoid malfunctions, detection and evaluation of the position of the ratchet and the actuator are necessary. With only slight deflections of the actuator and the actuating element taking place the detection and evaluation can only be done with a complex sensor arrangement.

Therefore, the structural configuration of the lock has an effect on the requirements for the sensor arrangement. Separation between the structural configuration and the sensor concept is not possible.

### SUMMARY OF THE INVENTION

A primary object of the present invention is to provide a motor vehicle lock achieving low cost and maximum mechanical and control-engineering operating reliability.

This object is achieved by a motor vehicle lock having a latch with a pre-catch and a main catch which can be swiveled around one axis, and a ratchet which can be swiveled around one axis, wherein the latch and the ratchet can each be moved into an open position, into a pre-catch position and into a main catch position. The ratchet, when located in the pre-catch position and in the main catch position, being engaged to the pre-catch and the main catch of the latch, keeping the latch in the pre-catch position and main catch position with an actuator. The actuator has an actuating element with an engagement element located thereon such that, by actuating the actuator out of the initial position in the first direction, the ratchet can be raised by means of the actuating element, i.e., performing the opening assistance function, and by actuating the actuator out of the initial position in a second opposite direction, the actuating element can be coupled to the latch, and thus, the latch can be moved from the pre-catch position into the main catch position, i.e., performing the closing assistance function. The actuator which provides the coupling intended for the closing assistance function between the actuating element and the latch includes a step-down gear.

It is important for the coupling, which is intended to provide the closing assistance function between the actuating element and the latch, to have a step-down gear since the torque to be applied for the closing assistance function by the actuator is reduced relative to the torque necessary for implementing the opening assistance function. This enables the opening assistance function and the closing assistance function to be equalized to one another since the actuator is more uniformly loaded. Furthermore, the reduction of the required torque allows selection of a motor with correspondingly weaker torque which in turn leads to a cost reduction.

In the simplest embodiment of the invention, the step-down gear is made preferably as a disk-shaped transmission element which can be swiveled around an axis for coupling of the actuating element to the latch the transmission element via a first actuating surface and a second actuating surface. The actuating surfaces are arranged such that the desired step-down ratio is achieved. The configuration of the transmission element as a disk-shaped element leads to a space-saving and simple configuration.

According to another embodiment of the invention, the object is achieved by a motor vehicle lock with a latch which can be swiveled around an axis, the latch having a pre-catch and a main catch, and with a ratchet which can be swiveled around an axis such that the latch and the ratchet can each be moved into an open position, into a pre-catch position and into a main catch position. The ratchet, when located in the pre-catch position and main catch position, being associated with the pre-catch and the main catch of the latch and keeping the latch in the pre-catch position and main catch position.

The motor vehicle further includes two Hall sensors which are stationary relative to the ratchet. The ratchet has a magnet which cooperates with the two Hall sensors by moving the ratchet into the detection range of one of the two Hall sensors or into the detection ranges of both of the two Hall sensors or outside the detection ranges of the two Hall sensors, such that evaluation, by the sensor signals of the Hall sensors, of the position of the ratchet can be unambiguously determined.

This embodiment provides a solution which is especially reliable in terms of control engineering, and at the same time, simple in construction. That is, the detection of the position of the ratchet via two Hall sensors which are stationary relative to the ratchet in the motor vehicle lock provide a simple reliable construction. This construction includes a ratchet having a magnet which, depending on the position of the ratchet, lies in the detection ranges of the Hall sensors. For example, when the Hall sensors are located in the motor vehicle lock and the magnet is located on the ratchet such that the ratchet is in the open position the magnet is located outside the detection ranges of the two Hall sensors. Further, when the ratchet is in the pre-catch position the magnet is in the detection range of one of the two Hall sensors and when the ratchet is in the main catch position the magnet is in the detection ranges of both Hall sensors.

According to another embodiment of the invention, the object is achieved by a motor vehicle lock with a latch which can be swiveled around an axis, the latch having a pre-catch and a main catch and with a ratchet which can be swiveled around an axis such that the latch and the ratchet can each be moved into an open position, into a pre-catch position and into a main catch position. The ratchet which can be located in the pre-catch position or in main catch position being engaged with the pre-catch or the main catch of the latch. An actuator which keeps the latch in the pre-catch position or the main catch position has an actuating element with an engagement element located thereon such that by actuating the actuator out of the initial position in the first direction the ratchet can be raised by means of the actuating element, i.e., providing the opening assistance function, and by actuating the actuator out of the initial position in the second opposite direction the actuating element can be coupled to the latch and thus the latch can be moved from the pre-catch position into the main catch position, i.e., providing the closing assistance function. This embodiment is characterized by one Hall sensor which is stationary on the ratchet, and an actuating element on which there are positioned a first magnet, a second magnet, and a third magnet, such that, when the actuating element is moved out of the initial position in the first direction, the first magnet moves into the detection range of the Hall sensor, that when the actuating element is moved out of the initial position in the second opposite direction, the third magnet moves into the detection range of the Hall sensor, and that when the actuating element is moved out of the deflected position into the initial position the second magnet moves into the detection range of the Hall sensor.

In this embodiment, only one Hall sensor is provided which cooperates with three magnets offset at an angle on the actuating element. The magnets move into corresponding positions into the detection range of the Hall sensor.

The invention is explained in detail below with reference to the accompanying the drawings.

### BRIEF DESCRIPTION OF THE DRAWINGS

FIG. 1 schematically shows a motor vehicle lock with a latch and ratchet in the main catch position, the actuating element in the initial position;

FIG. 2 shows the motor vehicle lock of FIG. 1, in which the actuating element, with the engagement element, is at the start of the opening assistance function;

FIG. 3 shows the motor vehicle lock of FIG. 1, in which the ratchet is already moved into the pre-catch position;

FIG. 4 shows the motor vehicle lock of FIG. 1, in which the ratchet and the latch are in the open position, and the actuating element is reset into the initial position;

FIG. 5 shows the motor vehicle lock after a repeated closing process with a latch and ratchet in the pre-catch position, and the actuating element, with the engagement element, at the start of the closing assistance function; and

FIG. 6 shows the motor vehicle lock with the latch and the ratchet in the main catch position, at the end of the closing assistance function, and the actuating element positioned prior to the returning motion into the initial position.

### DETAILED DESCRIPTION OF THE INVENTION

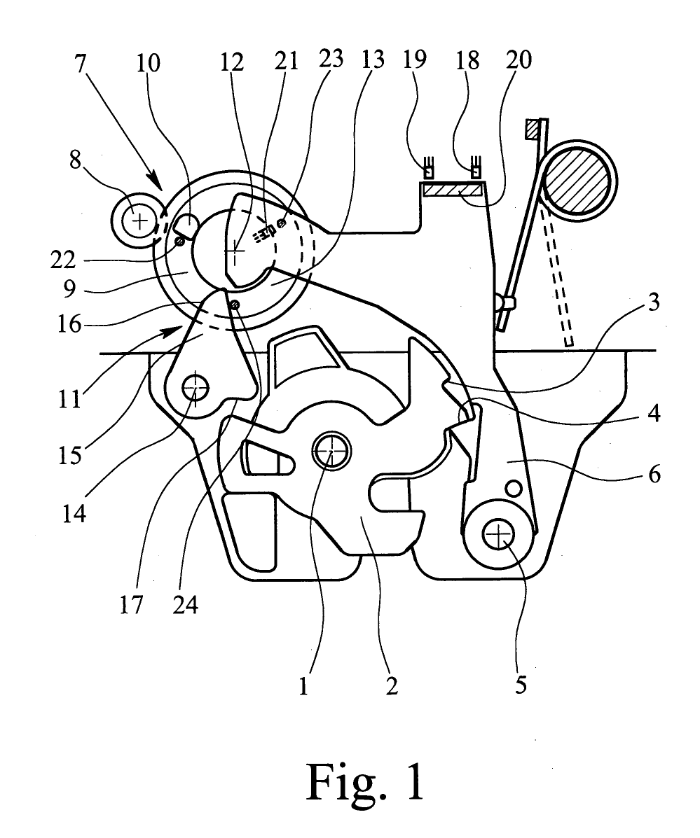

The motor vehicle lock of FIG. 1 has a latch 2, which can be pivot around an axis 1, a pre-catch 3 and a main catch 4. Additionally shown is a ratchet 6, which can be pivoted around an axis 5. The latch 2 and the ratchet 6 can each be moved into an open position, into a pre-catch position and into a main catch position. In FIG. 1, the latch 2 and the ratchet 6 are in the main catch position. The ratchet 6, when in the pre-catch position or the main catch position, is engaged with the pre-catch 3 or the main catch 4 of the latch 2, respectively, and keeps the latch 2 in the pre-catch position or in the main catch position. The motor vehicle lock has an actuator 7 which has a actuating element 9 which can be driven by a drive motor 8 with the engagement element 10 located on it. The actuator 7 ensures an opening assistance function and a closing assistance function which will be discussed below.

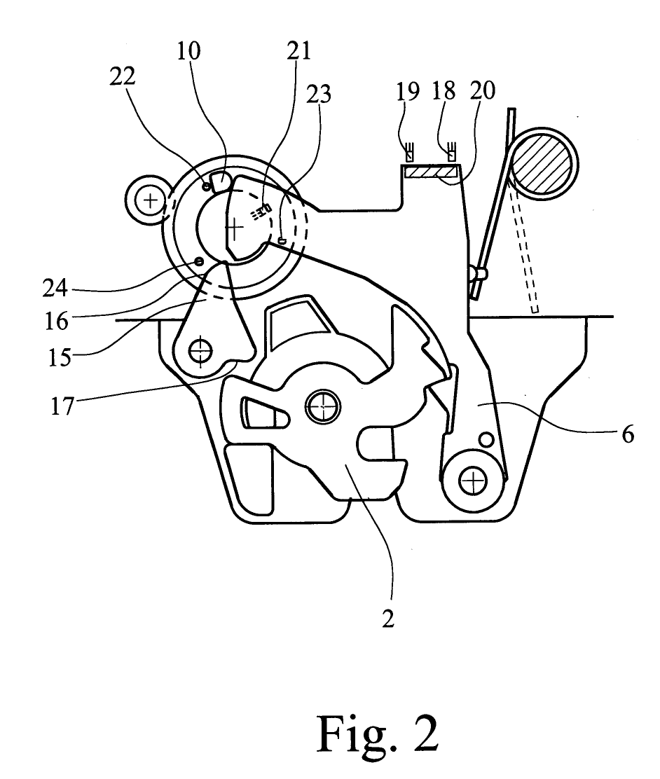

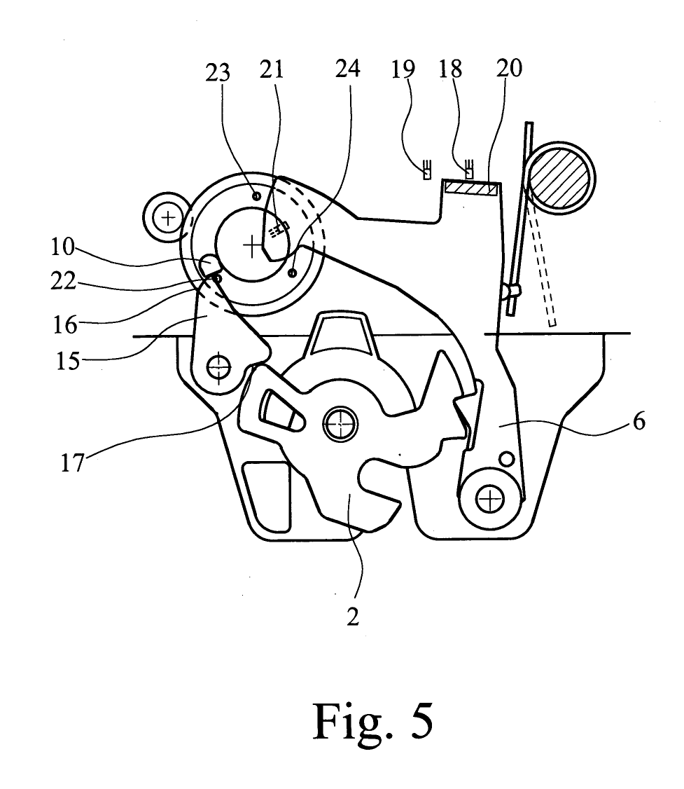

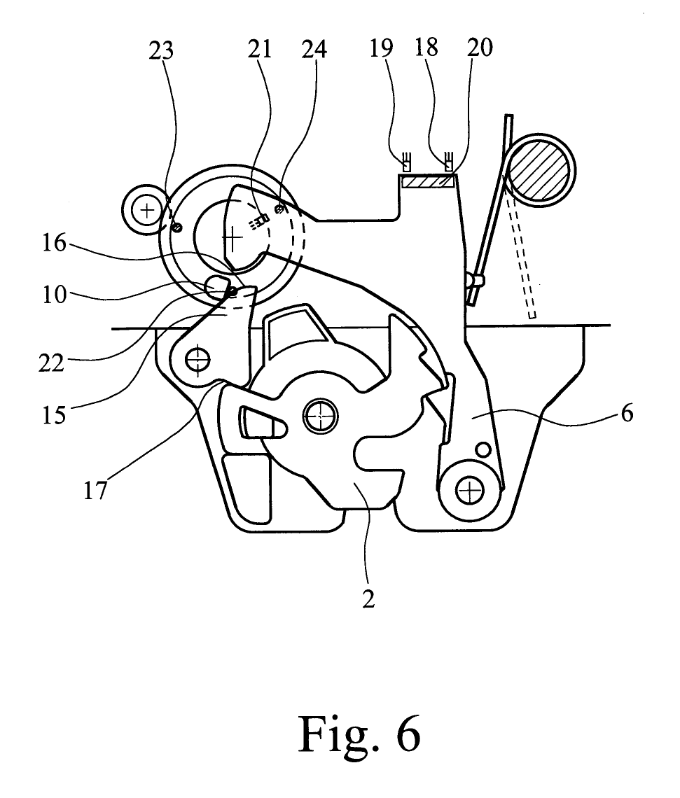

By actuating the actuator 7 from the illustrated initial position in FIG. 1 in a first direction, that is, to the right (clockwise) in the drawings, the ratchet 6 is raised by means of the actuating element 9, with which the opening assistance function is accomplished, as illustrated in FIGS. 2-4. By actuating the actuator 7 out of the initial position in a second direction, which is opposite the first direction, to the left (counterclockwise) in the drawings, the actuating element 9 can be coupled to the latch 2. In this way, the latch 2 can be moved out of the pre-catch position into the main catch position, with which the closing assistance function is accomplished, as illustrated in FIGS. 5-6.

The coupling which is necessary for implementing the closing assistance function between the actuating element 9 and the latch 2 has a step-down gear 11 which is described below. As mentioned above, it is important that the torque on the actuating element 9 necessary for moving the latch 2 from the pre-catch position into the main catch position be reduced. The structural configuration shown in the drawings illustrates that the torque which is necessary for lifting the ratchet 6, as shown in FIGS. 2-4, is far less than the torque which is necessary for moving the latch 2 from the pre-catch position into the main catch position. That is, the torque that acts directly on the ratchet 6 and on the latch 2 is being described. Interposing the step-down gear 11 between the actuating element 9 and the latch 2, as shown in FIGS. 5 & 6, results in that the torque which is to be applied by the actuator 7 for implementing the opening assistance function and for implementing the closing assistance function are equalized relative to one another. It has already been explained that, in this way, the layout of the actuator 7, especially of the drive motor 8, is optimized and that by more uniform loading of the drive motor 8 its reliability and service life are increased.

The actuating element 9 of the actuator 7 can be turned around the axis 12 here, and for coupling to the ratchet 6 or to the latch 2, it has an engagement element 10. The axis 12 of the actuating element 9 is aligned essentially parallel to the axis 1 of the lock latch 2 and is spaced apart from it. This spacing of the axis 12 of the actuating element 9 leads to interposition of the step-down gear 11 between the actuating element 9 and the latch 2 being easily possible.

There are a series of alternatives for the structural configuration of the actuator 7, and in particular the actuating element 9. Specifically preferred is the configuration of the actuating element 9 as a worm wheel which can turn around the axis 12 with the engagement element 10 being a coupling journal which is located on the end face 13 of the worm wheel 9 and which extends parallel to the axis 12.

There are also numerous alternatives for the configuration of the step-down gear 11. The specifically preferred configuration of the step-down gear is illustrated in each of the drawing figures and functions as a transmission element 15 which can be swiveled around an axis 14. The configuration of the transmission element 15 can vary widely, as long as the following boundary conditions are met. That is, the transmission element 15 includes a first actuating surface 16 and a second actuating surface 17. As illustrated in FIGS. 5 & 6, when the actuating element 9 is moved counterclockwise around to the left, the engagement element 10 engages the first actuating surface 16 to cause the transmission element 15 to be moved clockwise around to the right such that the latch 2, which is in the pre-catch position, engages the second actuating surface 17. This non-positive connection between the actuating element 9 and the lock latch 2 is produced and ultimately guarantees the coupling between the actuating element 9 and the latch 2 which is necessary for the closing assistance function.

The illustrated length relationship of the actuating surfaces of the transmission element 15 establish that the transmission element 15 as simply a lever and further that the lever action is used here for the operation of the step-down gear 11.

Depending on the required step-down ratio, the step-down gear 11 can be provided with several stages which can be particularly advantageous when the lock is employed in motor vehicles having especially heavy doors that must be moved into their closed position by the actuator 7 during implementation of the closing assistance function.

According to another embodiment of the invention, the opening assistance function is triggered by an actuating button which is located outside on the hatch (rear hatch or the like). The closing assistance function is conversely triggered when the hatch, which is first open, is pressed so that the latch 2 and the ratchet 6 can be moved into the pre-catch position. Therefore, especially reliable detection of the state in which the latch 2 and the ratchet 6 are in the pre-catch position is necessary. The position of the ratchet 6 is determined for this purpose in a preferred embodiment.

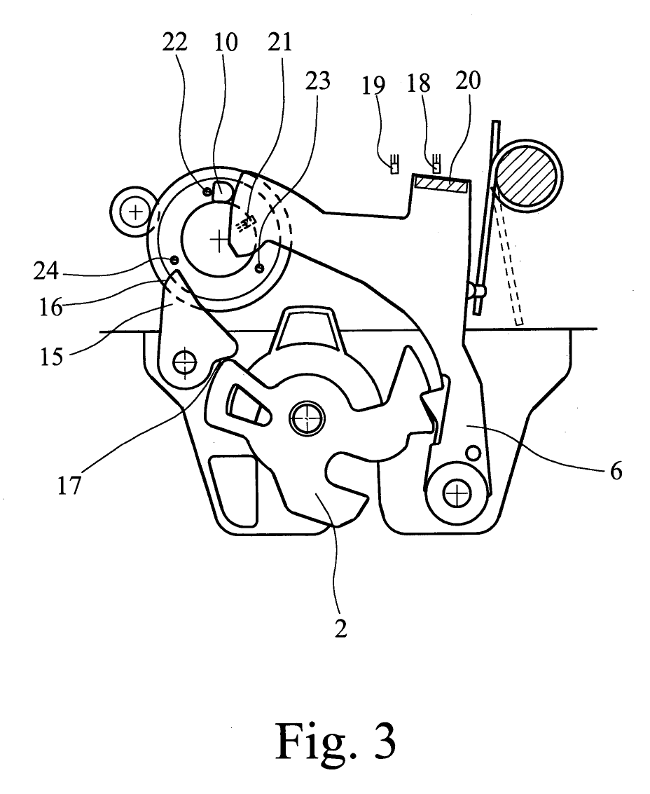

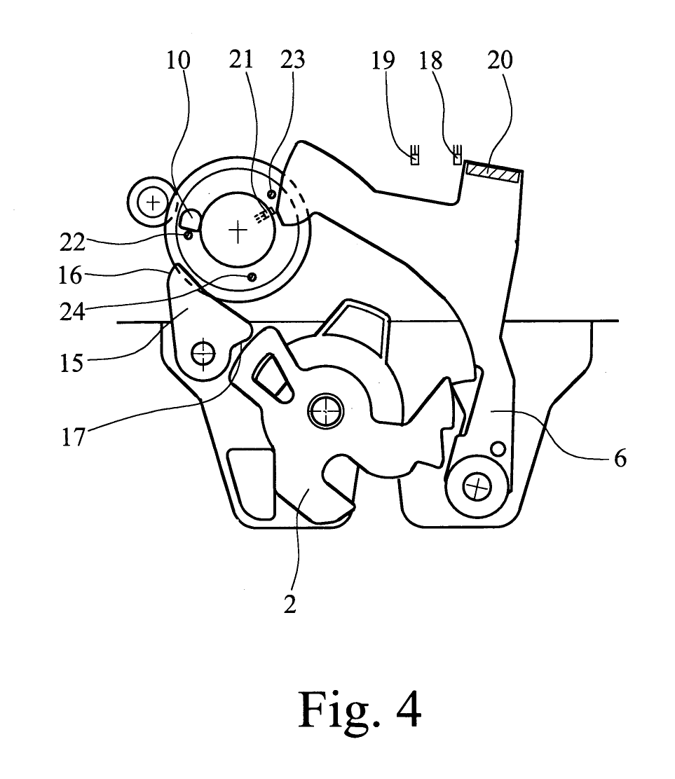

For determination of the position of the ratchet 6, in its vicinity there are two Hall sensors 18, 19. The ratchet 6 has one magnet 20 located in a receiver portion of the ratchet which, depending on the position of the ratchet 6, is in the detection range of one of the two Hall sensors 18, 19 as illustrated in FIGS. 3 & 5, or lies in the detection ranges of the two Hall sensors 18, 19 as illustrated in FIGS. 1, 2 & 6, or is in the detection ranges of neither of the two Hall sensors 18, 19 as illustrated in FIG. 4. Thus, the position of the ratchet 6 can be unambiguously determined by the corresponding determination of the sensor signals of the Hall sensors 18, 19.

In one especially preferred embodiment, when the ratchet 6 is in the open position, the magnet 20 is outside the detection ranges of the two Hall sensors 18, 19, as shown in FIG. 4. Further, when the ratchet 6 is in the pre-catch position, the magnet 20 is in the detection range of only one of the two Hall sensors 18, 19, specifically Hall sensor 18, as shown in FIGS. 3 & 5, and when the ratchet 6 is in the main catch position the magnet 20 is in the detection ranges of both of Hall sensors 18, 19, as illustrated in FIGS. 1, 2 & 6.

The determination of the three ratchet positions by two binary sensors offers the advantage of redundant coding. This means that, in the overall locking system, more sensor states are possible than positions to be determined. Here, three different sensor states are possible, while only three ratchet positions can be determined. As a result, the probability that faulty measurements will remain undetected, and thus, cause a malfunction is reduced since a faulty sensor signal with a certain probability leads to an “impermissible” signal state.

In the preferred embodiment, the magnet 20 is as far as possible from the axis 5 of the ratchet 6 so that even small deflections of the ratchet, for example, the movement of the ratchet 6 from the pre-catch position into the main catch position, are resolved by the two Hall sensors 18, 19 and can therefore be detected.

To implement the opening assistance function, the actuating element 9 of the actuator 7 is moved out of the initial position in the drawings around to the right until the ratchet 6 is raised. Then the actuating element 9 is set back into the initial position. To implement the closing assistance function, the actuating element 9 of the actuator 7 is moved around to the left until the latch 2 is in the main catch position. Then, the actuating element 9 in turn is set back into the initial position. The actuation of the actuating element 9 which is to be carried out for the opening assistance function and the closing assistance function therefore requires essentially one forward and backward motion of the actuating element 9.

One particularly simple embodiment for control of the above described movements of the actuating element 9 is provided by another Hall sensor 21 which is stationary relative to the actuating element 9 and a first magnet 22, a second magnet 23, and a third magnet 24 are positioned on the actuating element 9. When the actuating element 9 is moved out of the illustrated initial position, in FIG. 1, around to the right in the drawings, in FIGS. 2 & 3, the first magnet 22 moves into the detection range of the Hall sensor 21. Additionally, when the actuating element 9 is moved out of the initial position around to the left, in FIGS. 5 & 6, the third magnet 24 moves into the detection range of the Hall sensor 21, and when the actuating element 9 is moved out of the deflected position into the initial position, in FIG. 1, the second magnet 23 moves into the detection range of the Hall sensor 21.

With this single Hall sensor 21 and the three magnets 22, 23, 24 located on the actuating element 9, the end points of the movements of the actuating element 9, which are necessary for the opening assistance function and the closing assistance function, can be easily detected and controlled accordingly. It is noted that desired movements, can be largely optionally adjusted by selecting the configuration of the magnets 22, 23, 24.

In a preferred configuration, when the actuating element 9 is moved around to the right in the drawings by more than 90°, preferably by roughly 135°, in the first direction as in FIG. 1, the first magnet 22 moves into the detection range of the Hall sensor 21. In another preferred embodiment, the third magnet 24, when the actuating element 9 is moved in the second opposite direction around to the left in the drawings by more than 90°, preferably by roughly 125°, moves out of the initial position into the detection range of the Hall sensor 21.

Finally, each preferred embodiment also includes a central control device connected to the Hall sensors 18, 19, 21. The control device is programmed for each of the above described sequences of motion, particularly the above described change of direction.

What is claimed is:

1. A motor vehicle lock comprising:
a latch which includes a pre-catch and a main catch and is pivotable around a first axis into an open position, into a pre-catch position and into a main catch position;
a ratchet which is pivotable around a second axis into an open position, into a pre-catch position and into a main catch position; and
an actuating element which includes an actuator element having an engagement element located thereon;
wherein the latch is engaged with the pre-catch or the main catch when the ratchet is located in the pre-catch position or in the main catch position,
wherein the latch is kept in the pre-catch position or the main catch position until movement of the actuator element out of an initial position in a first direction such that the ratchet is raised by the actuating element resulting in an opening assistance function,
wherein the latch is movable from the pre-catch position into the main catch position by actuating the actuator element out of the initial position in a second direction opposite the first direction which couples the actuating element to the latch resulting in a closing assistance function, and
wherein coupling for the closing assistance function is effected by a step-down gear interposed between the actuating element and the latch.

2. The motor vehicle lock as claimed in claim 1, wherein the actuating element is rotatable about a third axis which is spaced apart from and aligned essentially parallel to said first axis, and wherein the engagement element provides a coupling to the ratchet during movement in the first direction and to the latch during movement in the second direction.

3. The motor vehicle lock as claimed in claim 2, wherein the actuating element is a worm wheel is rotatable around the third axis and the engagement element is a coupling journal located on an end face of the worm wheel and extends parallel to the third axis.

4. The motor vehicle lock as claimed in claim 1, wherein the step-down gear between the actuating element and the latch is an essentially disk-shaped transmission element which is pivotable around a fourth axis and includes a first actuating surface and a second actuating surface,
wherein the transmission element, via the first actuating surface, engages the engagement element of the actuating element during movement of the actuating element in the second direction which causes, via the second actuating surface, forced engagement of the latch for coupling of the actuating element to the latch.

5. The motor vehicle lock as claimed in claim 2, wherein the step-down gear between the actuating element and the latch is an essentially disk-shaped transmission element which is pivotable around a fourth axis and includes a first actuating surface and a second actuating surface,
wherein the transmission element, via the first actuating surface, engages the engagement element of the actuating element during movement of the actuating element in the second direction which causes, via the second actuating surface, forced engagement of the latch for coupling of the actuating element to the latch.

6. The motor vehicle lock as claimed in claim 1, wherein the step-down gear includes several stages.

7. A motor vehicle lock comprising:
a latch which includes a pre-catch and a main catch and is pivotable around a first axis into an open position, into a pre-catch position and into a main catch position;
a ratchet which includes a magnet and is pivotable around a second axis into an open position, into a pre-catch position and into a main catch position; and
two Hall sensors located in a stationary position relative to the ratchet and each being capable of generating a sensor signal;
wherein the latch is engaged with the pre-catch or the main catch, when the ratchet is located in the pre-catch position or in the main catch position
wherein the two Hall sensors and the magnet on the ratchet are arranged such that the magnet is moved by moving the ratchet into detection range of one of the two Hall sensors, into the detection ranges of the two Hall sensors and outside the detection ranges of the two Hall sensors, and
wherein a control is provided for determining the position of the ratchet from the sensor signals generated by of the Hall sensors.

8. The motor vehicle lock as claimed in claim 7, wherein the magnet is located outside the detection ranges of the two Hall sensors when the ratchet is in the open position, wherein the magnet is in the detection range of one of the two Hall sensors when the ratchet is in the pre-catch position and wherein the magnet is in the detection ranges of both Hall sensors when the ratchet is in the main catch position.

9. The motor vehicle lock as claimed in claim 7, wherein the ratchet includes a receiver portion for the magnet which is spaced apart from the second axis such that the two Hall sensors detect movement of the ratchet from the open position into the pre-catch position and from the pre-catch position into the main catch position.

10. The motor vehicle lock as claimed in claim 8, wherein the ratchet has a receiver portion for the magnet which is spaced apart from said second axis of the ratchet such that the two Hall sensors detect movement of the ratchet from the open position into the pre-catch position and from the pre-catch position into the main catch position.

11. The motor vehicle lock as claimed in claim 7, further comprising an actuating element having an engagement element located thereon; and
a third Hall sensor which is stationary relative to the actuating element,
wherein the actuating element has first, second and third spaced apart magnets mounted thereon,
wherein the latch is kept in the pre-catch position or the main catch position until the movement of the actuator element out of an initial position in a first direction such that the ratchet can be raised by the actuating element resulting in an opening assistance function,
wherein the latch is movable from the pre-catch position into the main catch position by actuating the actuator element out of the initial position in a second direction opposite the first direction which couples the actuating element to the latch resulting in a closing assistance function,
wherein the first magnet moves into the detection range of the third Hall sensor when the actuating element is moved out of the initial position in the first direction,
wherein the third magnet moves into the detection range of the third Hall sensor when the actuating element is moved out of the initial position in the second direction, and
wherein the second magnet moves into the detection range of the third Hall sensor when the actuating element is moved out of the deflected position into the initial position.

12. The motor vehicle lock as claimed in claim 11, wherein the first magnet moves into the detection range of the third Hall sensor when the actuating element is moved out of the initial position by more than 90° in the first direction.

13. The motor vehicle lock as claimed in claim 11, wherein the first magnet moves into the detection range of the third Hall sensor when the actuating element is moved out of the initial position by approximately 135° in the first direction.

14. The motor vehicle lock as claimed in claim 11, wherein the third magnet moves out of the initial position into the detection range of the third Hall sensor when the actuating element is moved by more than 90° in the second direction.

15. The motor vehicle lock as claimed in claim 11, wherein the third magnet moves out of the initial position into the detection range of the third Hall sensor when the actuating element is moved approximately 125° in the second direction.

16. The motor vehicle lock as claimed in claim 7, further including a control device which is connected to each of two Hall sensors.

17. The motor vehicle lock as claimed in claim 11, further including a control device which is connected to each of three Hall sensors.

18. The motor vehicle lock as claimed in claim 1, further comprising two Hall sensors located in a stationary position relative to the ratchet and each capable of generating a sensor signal,
wherein the ratchet includes a magnet, and
wherein the two Hall sensors and the magnet on the ratchet are arranged such that the magnet can be moved, by movement of the ratchet, into detection range of one of the two Hall sensors, into the detection ranges of the two Hall sensors and outside the detection ranges of the two Hall sensors and
wherein the position of the ratchet can be determined from sensor signals generated by the Hall sensors.

19. The motor vehicle lock as claimed in claim 18, wherein the magnet is located outside the detection ranges of the two Hall sensors when the ratchet is in the open position,
wherein the magnet is in the detection range of one of the two Hall sensors when the ratchet is in the pre-catch position, and
wherein the magnet is in the detection ranges of both Hall sensors when the ratchet is in the main catch position.

20. The motor vehicle lock as claimed in claim 18, wherein the ratchet includes a receiver portion for the magnet which is spaced apart from the second axis such that the movement of the ratchet from the open position into the pre-catch position and from the pre-catch position into the main catch position is sensed by the two Hall sensors.

21. The motor vehicle lock as claimed in claim 19, wherein the ratchet includes a receiver portion for the magnet which is spaced apart from the second axis of the ratchet such that the movement of the ratchet from the open position into the pre-catch position and from the pre-catch position into the main catch position is sensed by the two Hall sensors.

22. A motor vehicle lock comprising:
a latch which includes a pre-catch and a main catch and is pivotable around a first axis into an open position, into a pre-catch position and into a main catch position;
a ratchet which is pivotable around a second axis into an open position, into a pre-catch position and into a main catch position;
an actuating element having first, second and third spaced apart magnets mounted thereon; and
a Hall sensor which is stationary relative to the actuating element,
wherein the latch is engaged with the pre-catch or the main catch when the ratchet is located in the pre-catch position or in the main catch position,
wherein the latch is kept in the pre-catch position or the main catch position until the movement of the actuator element out of an initial position in a first direction such that the ratchet is raised by the actuating element resulting in an opening assistance function,
wherein the latch is moved from the pre-catch position into the main catch position by actuating the actuator element out of the initial position in a second direction opposite the first direction which couples the actuating element to the latch resulting in a closing assistance function, and
wherein the first magnet moves into the detection range of the Hall sensor when the actuating element is moved out of the initial position in the first direction,
wherein the third magnet moves into the detection range of the Hall sensor when the actuating element is moved out of the initial position in the second direction, and
wherein the second magnet moves into the detection range of the Hall sensor when the actuating element is moved out of the deflected position into the initial position.

23. The motor vehicle lock as claimed in claim 22, wherein the first magnet moves into the detection range of the Hall sensor when the actuating element is moved out of the initial position by more than 90° in the first direction.

24. The motor vehicle lock as claimed in claim 22, wherein the first magnet moves into the detection range of the Hall sensor when the actuating element is moved out of the initial position by approximately 135° in the first direction.

25. The motor vehicle lock as claimed in claim 22, wherein the third magnet moves out of the initial position into the detection range of the Hall sensor when the actuating element is moved by more than 90° in the second direction.

26. The motor vehicle lock as claimed in claim 22, wherein the third magnet moves out of the initial position into the detection range of the Hall sensor when the actuating element is moved approximately 125° in the second direction.

27. The motor vehicle lock as claimed in claim 22, further including a control device which is connected to the Hall sensor.
